(19) United States
(12) Patent Application Publication
(10) Pub. No.: US 2007/0289459 A1
(43) Pub. Date: Dec. 20, 2007

(54) Wet trapping method

(76) Inventors: Mikhail Laksin, Boonton, NJ (US); Wojciech A. Wilczak, Jersey City, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/454,588

(22) Filed: Jun. 16, 2006

(51) Int. Cl. B41F 5/16

(52) U.S. Cl. 101/177

(57) ABSTRACT

A method is disclosed, whereby low viscosity flexograhic printing inks used in implementing wet trapping of sequentially applied ink layers are partially cured to increase the first applied layer viscosity sufficiently to wet trap a subsequently applied superposed ink layer.

### FIELD OF THE INVENTION

The invention relates to a method for flexographic color printing and more particularly to a method for implementing a method of wet trap printing also known as “wet trapping” in flexographic printing. Specifically, the method relates to applying several liquid ink layers, one of which being energy curable and partially cured to increase its viscosity during “wet trapping”.

### BACKGROUND OF THE INVENTION

Multicolor printing processes typically require the sequential printing of a plurality of superposed single color ink layers. When high quality image reproduction is desired, it is important to avoid a previously applied ink layer mixing with a subsequently applied ink layer. Such layer mixing typically results in undesirable color rendition.

The art has addressed this problem in a number of different ways. The simplest way to prevent undesirable color mixing is to dry each applied ink layer prior to the application of a superposed next ink layer. While this method is effective it suffers a major disadvantage of requiring complete drying after applying each ink layer. Drying takes time and energy to accomplish, and as a result, productivity is reduced and production costs increase.

In an effort to speed up the printing process, wet trapping was developed. Wet trapping is a process whereby the ink layer deposited or applied at each inking station is not dried before the next ink layer is deposited thereover to produce a coloristic or visual effect. To implement wet trapping, it is important that the tack characteristics of the superposed ink layers be different.

Wet trapping is not a serious problem in offset printing, because the viscosity of the inks used in offset printing, ranges from 20,000 to 100,000 cps. Such high viscosity inks exhibit a wide range of tack characteristics that can be used to effect wet trapping without the need to dry the ink layers between inking stations.

In recent years, a form of printing that permits printing on various kinds of substrates, varying from cardboard to polyethylene to metal, has become widely accepted. This printing method is known as flexography.

Flexography employs a resilient printing plate having raised portions, which are coated with an ink and pressed against a substrate to transfer the ink to the substrate. In flexography, ink is transferred from a reservoir to the printing plate's raised surface through an intermediate transfer roll known in the art as an anilox roll. The anilox roll surface is covered by a plurality of tiny ink wells that fill with ink from the reservoir and transfer it to the flexographic printing plate. Obviously high quality printing requires that the flexographic printing plate surface be inked uniformly and consistently. This in turn requires that the anilox roll cells be small and that all of the anilox cells be filled each time with ink from the reservoir to substantially the same level.

Such requirement poses limitations on the fluidity or viscosity of the ink. A viscous ink will not be picked up as uniformly or consistently by the anilox roll and the flexographic printing plate surface will not be inked uniformly. The result has been that inks suitable for flexographic applications typically have viscosities under 2,000 cps, preferably less than 400 cps.

Current regulations regarding solvent emissions have resulted in the development of inks suitable for use in flexography that are energy curable. Such inks contain little or no solvent, and are fixed to the substrate not by drying but by curing via actinic radiation, such as ultraviolet light or electron beam. Their tack is very low and cannot be adequately measured with conventional instruments. Their viscosities are in the range of about 300 to 500 cps. While such viscosity range results in superior flexographic printing, energy-curable inks for flexographic applications exhibit very low tack, cannot be tack rated, and need be to cured between inking stations to prevent back transfer and mixing from the printed ink on the substrate to the inking rolls of subsequent stations. Such curing is undesirable from a manufacturing stand point, as it increases the time required between the deposition of a subsequent ink layer in order to allow for complete curing of the previously deposited ink layer, thereby slowing down the printing process. In addition, such inks must contain enough quantities of photoinitiators that can cause complete curing upon exposure to actinic radiation. The photoinitiators in such quantities are not desirable, in particular in food packaging products, because they belong to the so called migratory species and thus usually migrate their way into food products.

Wet trapping has also been proposed in flexographic printing based on the recognition that when depositing superposed multiple layers of ink, mixing will not occur if each layer is deposited over a layer having a higher viscosity than the newly deposited layer. The highest viscosity layer traps, so to speak, the second layer without mixing with or transfer of the underlying layer. However, with the range of viscosities available for flexographic printing inks, it is impractical to implement wet trapping using constantly decreasing ink viscosities for each layer that are sufficiently different from each previously applied layer viscosity in order to effect wet trapping, particularly as the number of applied layers increases. In essence, one runs out of available ink viscosities to implement wet trapping.

U.S. Pat. No. 5,690,028 attempts to solve the above mentioned problem of limited available ink viscosity range using a method of wet trapping in a multicolor printing application using energy curable inks, particularly suited for a central impression press. According to this patent, the energy curable inks are heated before being applied to a substrate, and are applied to the substrate at a temperature that is higher than the previously applied ink layer. Because the temperature of the previously applied ink layer on the substrate is cooler than the heated ink, the viscosity of the previously applied ink layer is lower than the viscosity of the applied ink. This viscosity differential causes the lower viscosity ink to unilaterally transfer onto the higher viscosity ink and prevents both back trapping and ink blending.

While this method of wet trapping achieves the desired result, it requires substantial modification to the existing printing press equipment to provide for heating units in each inking station before the ink is applied to the substrate, moreover, as the number of stations increases, so must the ink temperature in the successive inking stations. Thus, it may be necessary to apply cooling to the substrate, or the printing speed may have to be reduced, in order to prevent having to increase the ink temperature to levels that may adversely affect its properties.

U.S. Pat. No. 6,772,683 discloses a method for the flexographic printing of multiple superposed ink layers on a substrate using at least one energy curable ink and printing a second ink thereover without prior curing of the first printed energy curable ink. This is accomplished by evaporating at least a portion of the non-reactive diluent in the earlier applied ink layer, thereby increasing its viscosity before applying a subsequent ink layer with lower viscosity. However, merely evaporating the non-reactive diluent to increase the ink viscosity may not be sufficient for proper performance, particularly at high printing speeds.

U.S. Pat. No. 5,407,708 discloses a method for applying and curing radiation curable inks to a substrate at successive printing stations comprising applying a first coating of the radiation curable ink to the substrate; irradiating the coated substrate with low level UV radiation for partially curing the first coating; applying a second coating to the substrate; and further radiating the coated substrate with EB radiation for finally curing the first coating and the second coating. This reference, however, requires partial curing by ultra violet radiation between each successive print station of the printing system. The present method is different than the method described in U.S. Pat. No. 5,407,708 because it does not call for partial curing between each succesive print station, i.e. it does not require the partial curing of each and every ink layer before applying the next layer in a flexographic printing ink process.

### SUMMARY OF THE INVENTION

The present invention provides a method for applying at least three ink layers on a substrate, said method comprising:
(a) applying onto said substrate an ink layer of an energy curable liquid ink having a viscosity of less than about 4000 cps, said applied energy curable ink layer having a first viscosity and containing an amount of photoinitiator(s) sufficient to cause a partial but not a complete cure of said ink;
(b) subjecting the said energy curable ink layer to actinic radiation, thereby causing said partial cure and increasing the viscosity of said applied energy curable ink layer;
(c) applying onto said previously partially cured ink layer of said energy curable ink liquid ink of increased viscosity, another layer of liquid ink not subject to curing or partial curing prior to application of next ink layer and having a viscosity lower than said inceased viscosity of said previously applied energy curable ink layer;
(d) applying onto said applied liquid ink layer of step (c) another layer of liquid ink; and
(e) fixing each said applied energy curable ink layer onto said substrate using electron beam radiation,
wherein at least one of the layers applied is not subject to curing or partial curing prior to application of a subsequent ink layer.

The present invention also provides a method for applying at least three ink layers on a substrate, said method comprising:
(a) applying onto said substrate an ink layer of an energy curable liquid ink having a viscosity of less than about 4000 cps, said applied energy curable ink layer having a first viscosity;
(b) subjecting said applied energy curable ink layer to level or type of actinic radiation sufficient to cause partial cure of said ink and increase the viscosity of said applied energy curable ink layer;
(c) applying onto said previously partially cured ink layer of said energy curable ink liquid ink of increased viscosity, another layer of liquid ink not subject to curing or partial curing prior to application of next ink layer and having a viscosity lower than said inceased viscosity of said previously applied energy curable ink layer;
(d) applying onto said applied liquid ink layer of step (c) another layer of liquid ink; and (e) fixing each said applied energy curable ink layer onto said substrate using electron beam radiation,
wherein at least one of the layers applied is not subject to curing or partial curing prior to application of a subsequent ink layer.

The present invention further provides a method for applying at least three ink layers on a substrate, said method comprising:
(a) applying onto said substrate a liquid ink layer which is not subject to curing or partial curing prior to application of next ink layer;
(b) applying onto said liquid ink layer an energy curable liquid ink having a viscosity of less than about 4000 cps, said applied energy curable ink layer having a first viscosity and containing an amount of photoinitiator(s) sufficient to cause a partial but not a complete cure of said ink;
(c) subjecting the said energy curable ink layer to actinic radiation, thereby causing said partial cure and increasing the viscosity of said applied energy curable ink layer;
(d) applying onto said previously partially cured ink layer of said energy curable liquid ink of inceased viscosity another layer of liquid ink having a viscosity lower than said increased viscosity of said previously applied energy curable inl layer; and
(e) fixing each said applied energy curable ink layer onto said substrate using electron beam radiation,
wherein at least one of the layers applied is not subject to curing or partial curing prior to application of a subsequent ink layer.

The present invention also provides a method for applying at least three ink layers on a substrate, said method comprising:
(a) applying onto said substrate a liquid ink layer which is not subject to curing or partial curing;
(b) applying onto said liquid ink layer an energy curable liquid ink having a viscosity of less than about 4000 cps, said applied energy curable liquid ink having a first viscosity;
(c) subjecting the said energy curable ink layer to a level or type of actinic radiation sufficient to cause a partial cure of said ink and increasing the viscosity of said applied energy curable ink layer;
(d) applying onto said previously partially cured ink layer of said energy curable liquid ink of inceased viscosity another layer of liquid ink having a viscosity lower than said increased viscosity of said previously applied energy curable ink layer; and
(e) fixing each said applied energy curable ink layer onto said substrate using electron beam radiation,
wherein at least one of the layers applied is not subject to curing or partial curing prior to application of a subsequent ink layer.

Other objects and advantages of the present invention will become apparent from the following description and appended claims.

### BRIEF DESCRIPTION OF THE DRAWINGS

The patent or application file contains at least one drawing executed in color. Copies of this patent or patent application publication with color drawings(s) will be provided by the Office upon request and payment of the necessary fees.

FIGS. 1A and 1B shows visual comparison of the screen area of the prints generated in Examples 1 (1A; Magenta dots over EB white ink) and Example 2 (1B; Magenta dots over UV/EB hybrid white ink) under ×20 magnification with an optical microscope.

### DETAILED DESCRIPTION OF THE INVENTION

It has now been surprisingly discovered that partially curing with actinic radiation at least one but not every energy curable flexographic ink layer before applying the next layer while printing at least 3 layers of inks results in making the printing more suitable for use in a wet trapping method for printing flexographic inks. This happens because of the increase in the viscosity of the partially cured ink layer. The ink layer to be partially cured is preferably the first layer applied on a substrate. Also preferably, all ink layers applied are energy curable. However, non-energy curable ink layers could also be used in the present invention.

Accordingly, the present invention relates to a novel process for implementing wet trapping of energy curable liquid flexographic inks in a flexographic printing environment, wherein the inks are preferably formulated using energy curable compositions containing an amount of photoinitiator(s) sufficient to cause only a partial curing and not a complete cure upon exposure to actinic radiation. Accordingly, such inks preferably contain only a limited amount of photoinitoators that are undesirable in food packaging products. Preferably, the amount of photoinitoators is less than about 10% by weight of the total weight of said energy curable liquid inks. Alternatively, the inks used in the present invention can be partially cured by being subjected to a reduced level or type of actinic radiation.

It has been now found that merely evaporating the non-reactive diluent as suggested by U.S. Pat. No. 6,772,683 to increase the ink viscosity may not be sufficient for proper performance. One such example is wet trapping over 100% coverage of white ink, in cases where the substrate is transparent, and the white ink is printed first to make the substrate look white and opaque. Thus, applying actinic radiation, preferably LED radiation, to said white energy-curable ink raises its viscosity more effectively that mere evaporation of an inert diluent such as water.

Specifically, 1% of Irgacure 819DW photoinitiator, which is a water-based dispersion of Irgacure 819 (BAPO [bis-acyl phosphine oxide]) were added to energy-curable White Uniqure ink also containing 7% water as inert diluent. The ink was printed on transparent OPP substrate and the water evaporated. Still, the ink was very soft to the touch. This softness negatively affects the printability over this ink on press.

The printed ink was then subjected to 0.5 sec exposure to 450 mW 395 nm LED array (UV Process Supply, part # A-160-008). The ink areas exposed to the 395 nm light were resistant to scratch while the unexposed areas scratched easily, indicating greater hardness and viscosity of the exposed areas.

The LED arrays are the preferred radiation sources to increase the viscosity of the wet-trappable inks as they emit very little heat so that heat sensitive substrates and equipment can be used. It is understood that LED arrays will not cause the complete curing of said energy-curable inks because of the limited amount of photoinitiator in said inks, but only cause partial curing, which, however, will beneficially increase their viscosity before the next ink layer is applied.

At the end of the present method, all the energy curable ink layers will be simultaneously fully cured, preferably by electron beam radiation.

These energy-curable liquid flexographic inks are single-, ternary- or quaternary-compositions that contain a resin that is neutralizable by acid or base, and a non-reactive diluent, such as an organic solvent, water or a combination thereof.

The compositions of this invention are energy curable. The term “energy-curable” composition, as used herein, is intended to mean compositions that are polymerizable or crosslinkable by the action of a radiant energy source of actinic radiation, such as ultraviolet radiation (UV) and electron beam radiation (EB). As used herein “actinic radiation” is intended to encompass radiation having a wavelength range from about 190 nm to about 400 nm, and preferably from about 240 nm to 400 nm. Actinic radiation of this type may be obtained from a variety of sources, e.g., mercury arc lamps, xenon arc lamps, light emitting diode, fluorescent lamps, monochromatic laser sources, and the like.

A “partially cured ink” for the purpose of the present invention is an ink that has been polymerized or crosslinked to a degree yet remains not completely fixed to the surface it is printed on and thus is not suited for commercial use.

In one embodiment, ink compositions suitable for use in the present invention contain a non-reactive diluent, preferably water. More preferably about 5 wt. % and 50 wt. % of said diluent comprises water. However compositions containing other non-reactive diluents, such as alcohol and mixtures of water and alcohol may be used. In practical terms, a water based ink composition is highly desirable, as its use complies with health and anti-pollution regulations that limit the amount of solvents permitted to escape in the environment. Therefore the present invention will be described using aqueous ink compositions, inasmuch as such compositions are the most likely to be used. Such limitation in the description of the invention is, however, not to be construed as limiting; and radiant energy curable inks of similar ink viscosity profiles and comparable non-reactive diluent evaporation characteristics are considered within the scope of the present invention.

The method provided by the present invention for applying multiple, at least partly superposed, ink layers on a substrate, relies on the rapid and relatively significant change in the viscosity of an energy curable liquid flexographic ink, after it has been deposited as a layer onto a substrate and subjected to partial curing by actinic radiation. Each ink layer is deposited onto the substrate in an inking station. There are as many inking stations as there are individual inks used in printing the color image. At each inking station, the ink is transferred from an ink reservoir through an anilox roll to a flexographic printing plate, such as a Cyrel.RTM. polymer printing plate produced by E. I. Dupont de Nemours and Company, Inc. The ink is then transferred from the printing plate onto a receiving substrate, such as a web or sheet of polyethylene terephthalate film, or any other substrate, which may be printed with a flexographic printing plate.

The initial viscosity of a liquid flexographic ink deposited onto the substrate is typically under 4000 cps, and preferably under 70 cps, although ink viscosities of 2,000 cps may be used, depending on the particular printing application. As discussed earlier, this very low viscosity is preferred in order to achieve good ink transfer from the ink reservoir through the anilox roll to the printing plate surface.

Once the ink has been deposited onto the substrate, it is subjected to actinic radiation causing partial but not complete curing and increasing its viscosity.

By the time the ink layer arrives at the next inking station, where another ink layer, typically of a different color, is deposited on the substrate and over at least portions, if not all, of the previously deposited ink layer, the ink viscosity of the deposited ink layer will have increased sufficiently to wet-trap that ink layer without back trapping the newly deposited ink, having a viscosity typically in the same range as that of the earlier deposited ink at the time of its deposition. Therefore, by partially curing energy curable inks, wet trapping of multiple ink layers can be implemented without the need to change ink viscosity by heating the ink, or chilling the substrate containing the ink layer, between inking stations, or completely curing the ink between inking stations.

According to the present invention, once all ink layers have been applied, a single curing step with a proper energy curing source such as an excessive dose of electron beam radiation is sufficient to fix all applied layers.

The present wet trapping process is not limited to the use of energy curable liquid flexographic inks, but may encompass the use of at least one layer of non-energy curable ink. For example, a layer of an energy curable liquid flexographic ink of the type disclosed above may be applied and the application of this layer to the substrate may be followed by the application of a layer of a non-energy curable liquid flexographic ink, this second layer having a viscosity that is less than the increased viscosity (through partial curing) of the first layer. Again, because of the viscosity differential, wet trapping may be implemented. If this second layer is the uppermost or last printed layer, all ink layers may be then be cured and dried via conventional drying means and methods, to simultaneously fix the deposited ink layers onto the substrate.

In yet another embodiment of the present invention, a number of energy curable and traditional ink layers may be inked in superposed fashion and still employ the wet-trapping technique of this invention. For example, as stated above, a first energy curable ink, having a first viscosity, may be applied as a first layer. A traditional ink layer, having a lower viscosity than the increased viscosity of the first ink layer, may then be applied over the increased viscosity layer at a subsequent inking station to form a second layer. A third layer may next be applied over the second layer using a second energy curable ink having a lower viscosity than the viscosity of the second layer. The viscosity of this layer will again increase by partial curing before reaching the next inking station. At the fourth inking station, a fourth layer may be applied over the third layer using yet another energy curable ink having a lower viscosity than the increased viscosity of the third layer. Drying of the conventional ink layer may be implemented if the conventional ink layer viscosity is so low that energy curable ink with lower viscosity is not available. Thus it is possible to implement the process of the present invention in what may be referred to as a “hybrid” process, whereby only a number of ink layers are implemented by viscosity gradient wet-trapping according to this invention, and wherein certain layers are dried or cured prior to the application of additional ink layers, using combinations of inks. Such a hybrid process, however, while possible and within the scope of the present invention, is less efficient than a process wherein all applied layers are an energy curable liquid flexographic ink.

### EXAMPLE 1 (COMPARATIVE)

Electron Beam (EB) curable white ink was printed on Central Impression (CI) flexo press manufactured by Ko-Pack, Japan utilizing photopolymer printing plate, 800 line/inch engraved anilox roller and clear OPP (oriented polypropylene) film. Then, four additional energy curable (EB curable) Unicure inks (from Sun Chemical), yellow (Y), magenta (M), cyan (C) and black (K) were printed on the top of this white in consecutive printing stations of the press. Thereafter, all 5 layers were energy cured with 3 Mrads of Electron Beam radiation. Print densities achieved for each color are reported in Table 1 below.

### EXAMPLE 2

1% of Irgacure 819DW, free radical photoinitiator manufactured by Ciba was added to the white ink composition of Example 1 and the printing cycle described in Example 1 was repeated, this time with exposure of the white ink to UV irradiation generated by medium pressure UV lamp prior to application of the subsequent ink layers. Specifically, the printed white ink was subjected to 0.5 sec exposure to 450 mW 395 nm LED array (UV Process Supply, part # A-160-008). Print densities achieved for Y, M, C and K colors are presented in Table 1 below.

TABLE 1
Print densities if the various inks in Examples 1 and 2

Print density

| | Y | M | C | K |
|---|---|---|---|---|
| Example 1 | 1.25 | 1.36 | 1.48 | 1.65 |
| Example 2 | 0.9 | 1.05 | 1.2 | 1.11 |

### EXAMPLE 3

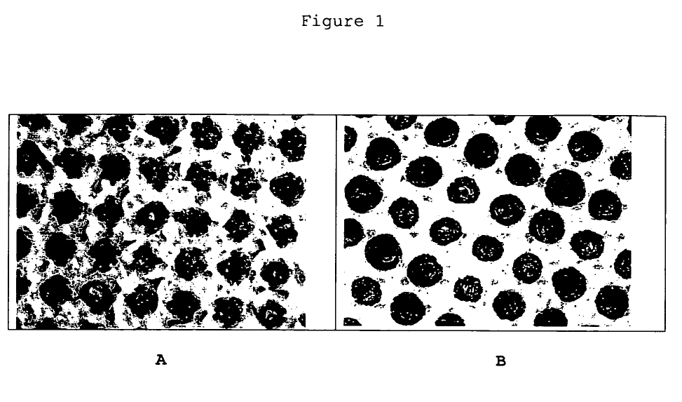

In this example, visual comparison of the screen area of the prints generated in Examples 1 and 2 was performed under ×20 magnification with an optical microscope. The quality of printing dots (uniformity and shape consistency) can be seen in FIG. 1 as much higher in the case of the white ink exposed to UV irradiation.

The invention has been described in terms of preferred embodiments thereof, but is more broadly applicable as will be understood by those skilled in the art. The scope of the invention is only limited by the following claims.

What is claimed is:

1. A method for applying at least three ink layers on a substrate, said method comprising:
(a) applying onto said substrate an ink layer of an energy curable liquid ink having a viscosity of less than about 4000 cps, said applied energy curable ink layer having a first viscosity and containing an amount of photoinitiator(s) sufficient to cause a partial but not a complete cure of said ink;
(b) subjecting the said energy curable ink layer to actinic radiation, thereby causing said partial cure and increasing the viscosity of said applied energy curable ink layer;
(c) applying onto said previously partially cured ink layer of said energy curable ink liquid ink of increased viscosity, another layer of liquid ink not subject to curing or partial curing prior to application of next ink layer and having a viscosity lower than said inceased viscosity of said previously applied energy curable ink layer;
(d) applying onto said applied liquid ink layer of step (c) another layer of liquid ink; and
(e) fixing each said applied energy curable ink layer onto said substrate using electron beam radiation,
wherein at least one of the layers applied is not subject to curing or partial curing prior to application of a subsequent ink layer.

2. The method of claim 1, wherein said actinic radiation is from LED (light-emitting diode).

3. The method of claim 1, wherein said substrate is transparent.

4. The method of claim 1, wherein said energy curable liquid ink applied in step (a) is white.

5. The method of claim 1, wherein said photoinitiator(s) is present in an amount of less than about 10% by weight of the total weight of said energy curable liquid ink.

6. The method of claim 1, wherein said photoinitiator is bis-acyl phosphine oxide initiator (Irgacure 819).

7. The method of claim 1, wherein said photoinitiator is a water dispersion of bis-acyl phosphine oxide initiator (Irgacure 819DW).

8. The method of claim 1, wherein said energy curable liquid ink contains a non reactive diluent.

9. The method of claim 8, wherein said said non reactive diluent is water.

10. The method of claim 8, wherein between about 5 wt. % and 50 wt. % said of said diluent comprises water.

11. The method of claim 1, wherein all the layers applied are energy curable.

12. The method of claim 1, wherein the layers applied other then the energy curable liquid ink layer applied in step (a) are not energy curable.

13. The method of claim 1, wherein some the layers applied other then the energy curable liquid ink layer applied in step (a) are not energy curable and some are energy curable.

14. The method of claim 1, wherein at least one more layer of liquid ink is applied following step (d).

15. The method of claim 1, wherein following step (d), steps (a), (b), (c) and (d) are repeated at least one more time.

16. A method for applying at least three ink layers on a substrate, said method comprising:
(a) applying onto said substrate an ink layer of an energy curable liquid ink having a viscosity of less than about 4000 cps, said applied energy curable ink layer having a first viscosity;
(b) subjecting said applied energy curable ink layer to level or type of actinic radiation sufficient to cause partial cure of said ink and increase the viscosity of said applied energy curable ink layer;
(c) applying onto said previously partially cured ink layer of said energy curable ink liquid ink of increased viscosity, another layer of liquid ink not subject to curing or partial curing prior to application of next ink layer and having a viscosity lower than said inceased viscosity of said previously applied energy curable ink layer;
(d) applying onto said applied liquid ink layer of step (c) another layer of liquid ink; and
(e) fixing each said applied energy curable ink layer onto said substrate using electron beam radiation,
wherein at least one of the layers applied is not subject to curing or partial curing prior to application of a subsequent ink layer.

17. The method of claim 16, wherein said actinic radiation is from LED (light-emitting diode).

18. The method of claim 16, wherein said substrate is transparent.

19. The method of claim 16, wherein said energy curable liquid ink applied in step (a) is white.

20. The method of claim 16, wherein said energy curable liquid ink contains a non reactive diluent.

21. The method of claim 20, wherein said said non reactive diluent is water.

22. The method of claim 20, wherein between about 5 wt. % and 50 wt. % of said diluent comprises water.

23. The method of claim 16, wherein all the layers applied are energy curable.

24. The method of claim 16, wherein the layers applied other then the energy curable liquid ink layer applied in step (a) are not energy curable.

25. The method of claim 16, wherein some the layers applied other then the energy curable liquid ink layer applied in step (a) are not energy curable and some are energy curable.

26. The method of claim 16, wherein at least one more layer of liquid ink is applied following step (d).

27. The method of claim 16, wherein following step (d), steps (a), (b), (c) and (d) are repeated at least one more time.

28. A method for applying at least three ink layers on a substrate, said method comprising:
(a) applying onto said substrate a liquid ink layer which is not subject to curing or partial curing prior to application of next ink layer;
(b) applying onto said liquid ink layer an energy curable liquid ink having a viscosity of less than about 4000 cps, said applied energy curable ink layer having a first viscosity and containing an amount of photoinitiator(s) sufficient to cause a partial but not a complete cure of said ink;
(c) subjecting the said energy curable ink layer to actinic radiation, thereby causing said partial cure and increasing the viscosity of said applied energy curable ink layer;
(d) applying onto said previously partially cured ink layer of said energy curable liquid ink of inceased viscosity another layer of liquid ink having a viscosity lower than said increased viscosity of said previously applied energy curable inl layer; and
(e) fixing each said applied energy curable ink layer onto said substrate using electron beam radiation,
wherein at least one of the layers applied is not subject to curing or partial curing prior to application of a subsequent ink layer.

29. The method of claim 28, wherein said actinic radiation is from LED (light-emitting diode).

30. The method of claim 28, wherein said substrate is transparent.

31. The method of claim 28, wherein said energy curable liquid ink applied in step (b) is white.

32. The method of claim 28, wherein said energy curable liquid ink contains a non reactive diluent.

33. The method of claim 32, wherein said said non reactive diluent is water.

34. The method of claim 32, wherein between about 5 wt. % and 50 wt. % of said diluent comprises water.

35. The method of claim 28, wherein all the layers applied are energy curable.

36. The method of claim 28, wherein the layers applied other then the energy curable liquid ink layer applied in step (b) are not energy curable.

37. The method of claim 28, wherein some the layers applied other then the energy curable liquid ink layer applied in step (b) are not energy curable and some are energy curable.

38. The method of claim 28, wherein at least one more layer of liquid ink is applied following step (d).

39. The method of claim 28, wherein following step (d), steps (a), (b), (c) and (d) are repeated at least one more time.

40. A method for applying at least three ink layers on a substrate, said method comprising:
(a) applying onto said substrate a liquid ink layer which is not subject to curing or partial curing;
(b) applying onto said liquid ink layer an energy curable liquid ink having a viscosity of less than about 4000 cps, said applied energy curable liquid ink having a first viscosity;
(c) subjecting the said energy curable ink layer to a level or type of actinic radiation sufficient to cause a partial cure of said ink and increasing the viscosity of said applied energy curable ink layer;
(d) applying onto said previously partially cured ink layer of said energy curable liquid ink of inceased viscosity another layer of liquid ink having a viscosity lower than said increased viscosity of said previously applied energy curable ink layer; and
(e) fixing each said applied energy curable ink layer onto said substrate using electron beam radiation,
wherein at least one of the layers applied is not subject to curing or partial curing prior to application of a subsequent ink layer.

41. The method of claim 40, wherein said actinic radiation is from LED (light-emitting diode).

42. The method of claim 40, wherein said substrate is transparent.

43. The method of claim 40, wherein said energy curable liquid ink applied in step (b) is white.

44. The method of claim 40, wherein said energy curable liquid ink contains a non reactive diluent.

45. The method of claim 44, wherein said said non reactive diluent is water.

46. The method of claim 44, wherein between about 5 wt. % and 50 wt. % of said diluent comprises water.

47. The method of claim 44, wherein all the layers applied are energy curable.

48. The method of claim 40, wherein the layers applied other then the energy curable liquid ink layer applied in step (b) are not energy curable.

49. The method of claim 40, wherein some the layers applied other then the energy curable liquid ink layer applied in step (b) are not energy curable and some are energy curable.

50. The method of claim 40, wherein at least one more layer of liquid ink is applied following step (d).

51. The method of claim 40, wherein following step (d), steps (a), (b), (c) and (d) are repeated at least one more time.
